(19) United States
(12) Patent Application Publication
(10) Pub. No.: US 2004/0242422 A1
(43) Pub. Date: Dec. 2, 2004

(54) Herbicidal composition

(76) Inventor: Urs Hofer, Basel (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/491,021

(22) PCT Filed: Sep. 26, 2002
(86) PCT No.: PCT/EP02/10831

(30) Foreign Application Priority Data
Sep. 27, 2001 (CH) 1782/01
Mar. 14, 2002 (CH) 460/02

(51) Int. Cl. A01N 43/36

(52) U.S. Cl. 504/138

(57) ABSTRACT

Herbicidal synergistic composition which, in addition to comprising customary inert formulation adjuvants, comprises as active ingredient a mixture of

a) clodinafop-propargyl and

b) a synergistically effective amount of at least one compound from the group prosulfocarb, mesosulfuron, fenoxaprop-P-ethyl and mesotrione.

The present invention relates to a novel herbicidal synergistic composition comprising a combination of herbicidal active ingredients that is suitable for selective weed control in crops of useful plants, for example in cereal crops.

The invention relates also to a method of controlling weeds in crops of useful plants, and to the use of the novel composition for that purpose.

Clodinafop-propargyl has herbicidal activity, as is described, for example, in The Pesticide Manual, 12th Edition, BCPC, 2000, Entry No. 156.

Prosulfocarb, fenoxaprop-P-ethyl and mesotrione are likewise described in The Pesticide Manual, 12th Edition, BCPC, 2000, Entry No. 565, 331 and 500, respectively. Mesosulfuron is mentioned, for example, in WO 01/24633.

Surprisingly, it has now been found that a combination of variable amounts of at least two active ingredients, that is to say a combination of clodinafop-propargyl with at least one of the above-mentioned active ingredients, develops a synergistic action that is capable of controlling, both preemergence and post-emergence, the majority of the weeds occurring especially in crops of useful plants, without substantially damaging the useful plant.

There is therefore proposed according to the present invention a novel synergistic composition for selective weed control which, in addition to comprising customary inert formulation adjuvants, comprises as active ingredient a mixture of

a) clodinafop-propargyl and

b) a synergistically effective amount of at least one compound from the group prosulfocarb, mesosulfuron, fenoxaprop-P-ethyl and mesotrione.

It is surprising to a high degree that the combination according to the invention of the mentioned active ingredients exceeds the additive action on the weeds to be controlled that is to be expected in principle and thus broadens the range of action of both active ingredients especially in two respects: firstly, the rates of application of the individual compounds are reduced while a good level of action is maintained. Secondly, the composition according to the invention achieves a high level of weed control also in those cases where the individual substances, in the range of low rates of application, have become useless from the agronomic standpoint. The result is considerable broadening of the spectrum of weeds and an additional increase in selectivity in respect of the crops of useful plants, as is necessary and desirable in the case of an unintentional overdose of active ingredient. The composition according to the invention, while retaining excellent control of weeds in useful plants, also allows greater flexibility in succeeding crops.

The composition according to the invention can be used against a large number of agronomically important weeds, such as Digitaria, Setaria, Sinapis, Solanum, Echinochloa, Sorghum halepense, Rottboellia, Cyperus, Abutilon, Sida, Xanthium, Amaranthus, Chenopodium, Ipomoea, Galium, Viola and Veronica. The composition according to the invention is suitable for all methods of application conventionally employed in agriculture, for example pre-emergence application, post-emergence application and seed dressing. The composition according to the invention is suitable especially for controlling weeds in cereals as well as for non-selective weed control. Crops of useful plants are also to be understood as including crops that have been made tolerant to herbicides or classes of herbicides as a result of conventional methods of breeding or genetic engineering.

The composition according to the invention comprises the active ingredients in any desired mixing ratio, generally with an excess of one component over the other. Preferred mixing ratios between the active ingredients (clodinafop-propargyl to mixing partner) are from 8:1 to 1:5, preferably from 5:1 to 1:2.

Compositions that are very especially effective comprise the following active ingredient combinations: clodinafop-propargyl+prosulfocarb, clodinafop-propargyl+mesosulfuron, clodinafop-propargyl+fenoxaprop-P-ethyl, and clodinafop-propargyl+mesotrione. Further very suitable compositions comprise instead of clodinafop-propargyl a mixture of clodinafop-propargyl with cloquintocet-mexyl (Topik® or Celio®). Mixtures of clodinafop-propargyl with fenoxaprop-P-ethyl and mefenpyr-diethyl or isoxadifen are also especially important.

The rate of application can vary within wide limits and is dependent on the condition of the soil, the type of application (pre- or post-emergence; seed dressing; application to the seed furrow; no tillage application, etc.), the crop plant, the weed to be controlled, the prevailing climatic conditions and other factors determined by the type of application, the time of application and the target crop. In general, the active ingredient mixture according to the invention can be applied at a rate of application of from 0.1 to 5 kg of active ingredient mixture/ha.

Accordingly, there is also proposed according to the invention a selectively herbicidal composition which, in addition to comprising customary inert formulation adjuvants, such as carriers, solvents and wetting agents, comprises as active ingredient a mixture of

a) clodinafop-propargyl,

b) a synergistically effective amount of at least one compound from the group prosulfocarb, mesosulfuron, fenoxaprop-P-ethyl and mesotrione, and

c) an amount, effective for herbicide antagonism, of cloquintocet-mexyl as safener.

Cloquintocet-mexyl and mefenpyr-diethyl are described in The Pesticide Manual, 12th Edition, BCPC, 2000, Entry No. 492 and 163, respectively. Isoxadifen is mentioned, for example, in DE 43 31 448 A1.

The active ingredients employed according to the invention may be used in unmodified form, that is to say as obtained in synthesis, but they are preferably formulated in customary manner together with the adjuvants conventionally employed in formulation technology, such as solvents, solid carriers or surfactants, for example into emulsifiable concentrates, directly sprayable or dilutable solutions, wettable powders, soluble powders, dusts, granules or microcapsules, as is described on pages 9 to 13 of WO 97/34483. As with the nature of the compositions, the methods of application, such as spraying, atomising, dusting, wetting, scattering or pouring, are chosen in accordance with the intended objectives and the prevailing circumstances. The formulations, that is to say the compositions, preparations or mixtures comprising the mixtures according to the invention and, optionally, one or more solid or liquid formulation adjuvants, are prepared in a manner known per se, e.g. by intimately mixing and/or grinding the active ingredients with the formulation adjuvants, for example solvents or solid carriers. Surface-active compounds (surfactants) may additionally also be used in the preparation of the formulations.

Examples of solvents and solid carriers are given, for example, on page 6 of WO 97/34485. Depending on the nature of the compound of formula I to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, on pages 7 and 8 of WO 97/34485. In addition, the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981, and M. and J. Ash, “Encyclopedia of Surfactants”, Vol. I-III, Chemical Publishing Co., New York, 1980-81, are also suitable for the preparation of the herbicidal compositions according to the invention.

The herbicidal formulations generally comprise from 0.1 to 99% by weight, especially from 0.1 to 95% by weight, of active ingredient mixture according to the invention, from 1 to 99.9% by weight of a solid or liquid formulation adjuvant, and from 0 to 25% by weight, especially from 0.1 to 25% by weight, of a surfactant.

Whereas commercial products will preferably be formulated as concentrates, the end user will normally employ dilute formulations. The compositions may also comprise further additives, such as stabilisers, for example vegetable oils or epoxidised vegetable oils (epoxidised coconut oil, rapeseed oil or soybean oil), anti-foams, for example silicone oil, preservatives, viscosity regulators, binders, tackifiers, and also fertilisers or other active ingredients. Preferred formulations have especially the following compositions: (%=percent by weight).

Emulsifiable Concentrates:

active ingredient mixture: 1 to 90%, preferably 5 to 20%

surface-active agent: 1 to 30%, preferably 10 to 20%

liquid carrier: 5 to 94%, preferably 70 to 85%

Dusts:

active ingredient mixture: 0.1 to 10%, preferably 0.1 to 5%

solid carrier: 99.9 to 90%, preferably 99.9 to 99%

Suspension Concentrates:

active ingredient mixture: 5 to 75%, preferably 10 to 50%

water: 94 to 24%, preferably 88 to 30%

surface-active agent: 1 to 40%, preferably 2 to 30%

Wettable Powders:

active ingredient mixture: 0.5 to 90%, preferably 1 to 80%

surface-active agent: 0.5 to 20%, preferably 1 to 15%

solid carrier: 5 to 95%, preferably 15 to 90%

Granules:

active ingredient mixture: 0.1 to 30%, preferably 0.1 to 15%

solid carrier: 99.5 to 70%, preferably 97 to 85%

The following Examples further illustrate but do not limit the invention.

| | | | | |
|---|---|---|---|---|
| F1. Emulsifiable concentrates | a) | b) | c) | d) |

| | | | | |
|---|---|---|---|---|
| active ingredient mixture | 5% | 10% | 25% | 50% |
| calcium dodecylbenzene- | 6% | 8% | 6% | 8% |
| sulfonate | | | | |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic hydrocarbon | 85% | 78% | 55% | 16% |
| mixture C₉-C₁₂ | | | | |

Emulsions of any desired concentration can be produced from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol | 20% | 10% | — | — |
| (mol. wt. 400) | | | | |
| N-methyl-2-pyrrolidone | — | — | 30% | 10% |
| aromatic hydrocarbon | 75% | 60% | — | — |
| mixture C₉-C₁₂ | | | | |

The solutions are suitable for application in the form of micro-drops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium laurylsulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | | 88% | 62% | 35% |

The active ingredient is thoroughly mixed with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride, the solution is sprayed onto the carrier, and the solvent is subsequently evaporated off in vacuo.

| F5. Coated granules | a) | b) | c) |
|---|---|---|---|
| active ingredient mixture | 0.1% | 5% | 15% |
| polyethylene glycol | 1.0% | 2% | 3% |
| (mol. wt. 200) | | | |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-for-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be prepared by dilution with water.

It is often more practical for the active ingredients of the mixtures according to the invention to be formulated separately and then to be brought together in the desired mixing ratio in the applicator in the form of a “tank mixture” in water shortly before application.

### BIOLOGICAL EXAMPLES

### Example B1

### Pre-emergence Test

The test plants are sown in pots under greenhouse conditions. Standard soil is used as the cultivation substrate. At a pre-emergence stage, the herbicides are applied to the soil surface both alone and in the form of a mixture. The rates of application depend on the optimum concentrations determined under field or greenhouse conditions. The tests are evaluated after 2 to 4 weeks (100% action=plant has died off completely; 0% action=no phytotoxic action). The mixtures used in this test exhibit good results.

### Example B2

### Post-emergence Test

The test plants are grown in pots under greenhouse conditions to a post-application stage. Standard soil is used as the cultivation substrate. At a post-emergence stage, the herbicides are applied to the test plants both alone and in the form of a mixture. The rates of application depend on the optimum concentrations determined under field or greenhouse conditions. The tests are evaluated after 2 to 4 weeks (100% action=plant has died off completely; 0% action=no phytotoxic action). The mixtures used in this test exhibit good results.

1. A herbicidal synergistic composition which, in addition to comprising customary inert formulation adjuvants, comprises as active ingredient a mixture of
a) clodinafop-propargyl and
b) a synergistically effective amount of at least one compound from the group prosulfocarb, mesosulfuron, fenoxaprop-P-ethyl and mesotrione.

2. A herbicidal composition according to claim 1, which comprises as an additional component c) cloquintocet-mexyl as safener.

3. A herbicidal composition according to claim 1, which comprises as an additional component c) mefenpyr-diethyl or isoxadifen as safener.

4. A method of controlling undesired plant growth in crops of useful plants, which comprises allowing a herbicidally effective amount of a composition according to claim 1 to act on the cultivated plant or its locus.

5. A method according to claim 4, wherein the cultivated plant is a cereal.
